(19) United States
(12) Patent Application Publication
(10) Pub. No.: US 2011/0226550 A1
(43) Pub. Date: Sep. 22, 2011

(54) High-rise building evacuation slides description

(76) Inventor: Hien Minh Tran, Cumming, GA (US)

(21) Appl. No.: 12/661,402

(22) Filed: Mar. 17, 2010

(51) Int. Cl. A62B 1/20

(52) U.S. Cl. 182/48

(57) ABSTRACT

This invention's purpose is to quickly and safely evacuate people from the highest stories of a high-rise building. It is a slide, much like those on airplanes, but with more features and uses. Another part of this creation is a movable slide that is attached to a funnel, which can be carried around on fire trucks and attached to the fire truck's crane when needed for use. There is also a machine that can be used to re-wrap the slide once it has been used. The slides are packed inside an exact windowsill and will roll out of its storage space when called for. There is one every few stories and the slides are at intervals so that no collision will occur. Another feature of the slide is clear plastic covering over the top to keep people in and make it possible to direct traffic. The most important attribute of this invention is the plastic sheets that keep the walls and the slide stiff. It is through these that the air is pumped into the slide. They are the structure of the slide, keeping it from collapsing at high elevations and steep inclines.

### FIELD OF INVENTION

This invention relates to evacuation slides and other devices used for the evacuation of people on high-rise structures. And also added is an invention of a machine that automatically rolls the inflatable evacuation slides up after use.

### HISTORY OF INVENTION

After the 9/11 incident in 2001, many people have tried to find ways of evacuating more people from higher stories of a high-rise building more quickly and easily. In the past, there have been inventions that use specific devices that ought to be carried around while in the high-rise buildings, some have been thought to use poles and platforms to bring people down, and yet others have thought of the use of chutes and slides. Some ideas that use the poles and platforms include vertical transportation downwards with the use of harnesses, and the platforms to help the handicapped; lines cast out from fire trucks for people to slide down; and poles that carry people down by holding on to ropes. The use of chutes and slides as a form of escape is thought of differently from the many inventions, some use a metal body form for support, and then slide out the body of it to use when needed, while others use air pressure to slow the descent from a free fall within a chute, and yet others let people sit on plastic tubes to go down many floors through a chute within a building.

### SUMMARY OF THE INVENTION

This invention makes evacuation from a high-rise building quicker, safer, and more efficient. First, if a fire or any other emergency occurs, the evacuation slides 13 will be pushed out through windows 15 from higher floors, allowing people to go down. Then, fire trucks 16 will also come and make additional funnels 20 that allow people to jump down from the lower floors to make the evacuation from the high-rise buildings quicker and much more efficient. The inflatable slides 13 will emerge when air is blown into the inflatable, and water 22 will be sprinkled into it. There will be a four foot deep pool 10 at the bottom where firemen will pull the people out. The slide also has adjustable decelerators 30 and decelerator blocks 27 to make the ride down safer. Another reason the slide is safer is because the slide is supported by foldable plastic 29 and safety cables 11 so it will not bend with extra weight. The funnels 20 will be held by steel rods 18 connected to a steel frame around its top.

When someone jumps on the plastic polyester fabric 20 from the lower floors, it will not make them bounce so high that they will fall out and neither is it so hard that it will break bones. Once the person starts falling down the chute 23, the adjustable decelerators 30 and decelerator blocks 27 will slow down their free fall until they get to the bottom of the four foot deep pool 10, where the firemen will help them out.

Both the funnels' slides 23 and the slides 13 have the same layers that are shown in some of the drawings.

The folding machine first uses its claws 31 to wrap around one end of the inflatable slide 13, and then the motor 32 starts spinning the claw 31 after it is locked at the end by the lock pin 36. The motor 32 turns by being connected to railings 33 and slowly sliding along the rail 33. In the end, the slide 13 will be rolled into a tubular shape again to be reused.

### BRIEF DESCRIPTION OF DRAWINGS

The drawings of this invention will hereby be described:

FIG. 1 is a side view picture of the evacuation slide with its layers and fully operational on the top floor of a high-rise building.

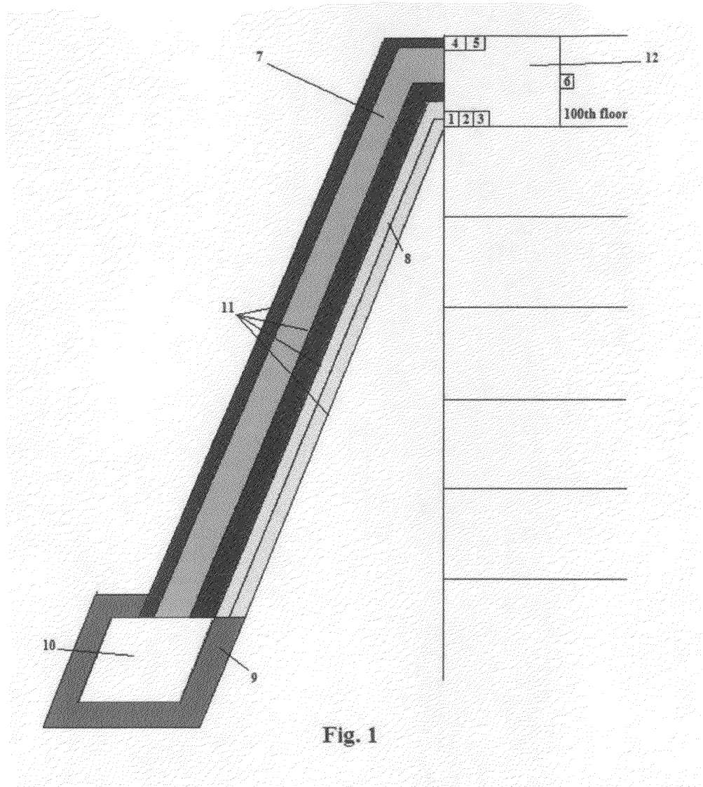

FIG. 2 is a helicopter view of a high rise building during evacuation mode without the fire trucks and the funnels there yet.

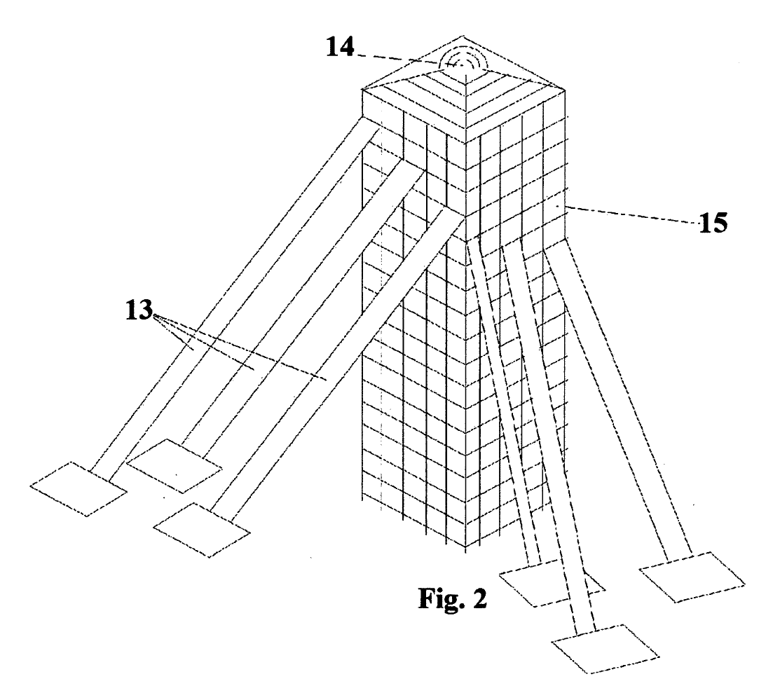

FIG. 3 is a side view of a funnel held up by a fire truck ladder and with people using it to evacuate from a high-rise building's lower floors.

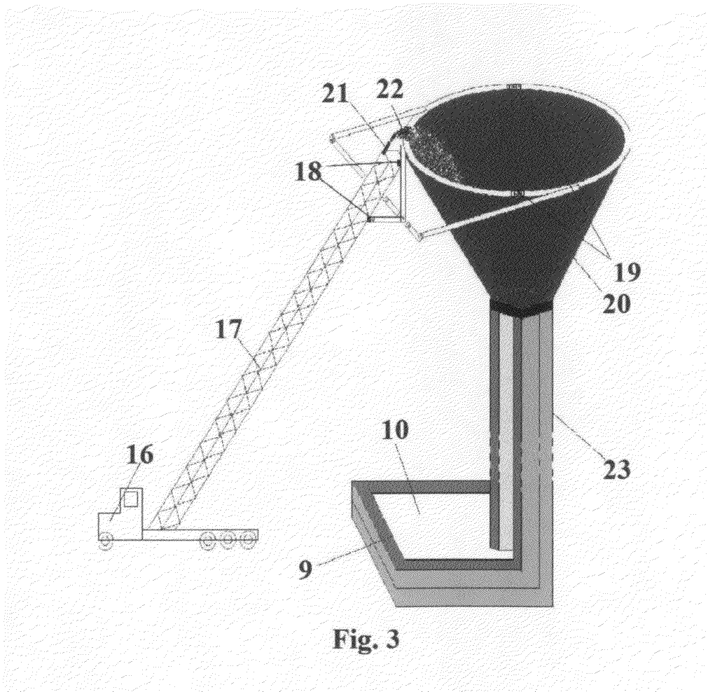

FIG. 4 is an opened top-right view of the layers of the slide and the funnel. These layers of the slides will make the people evacuating safer.

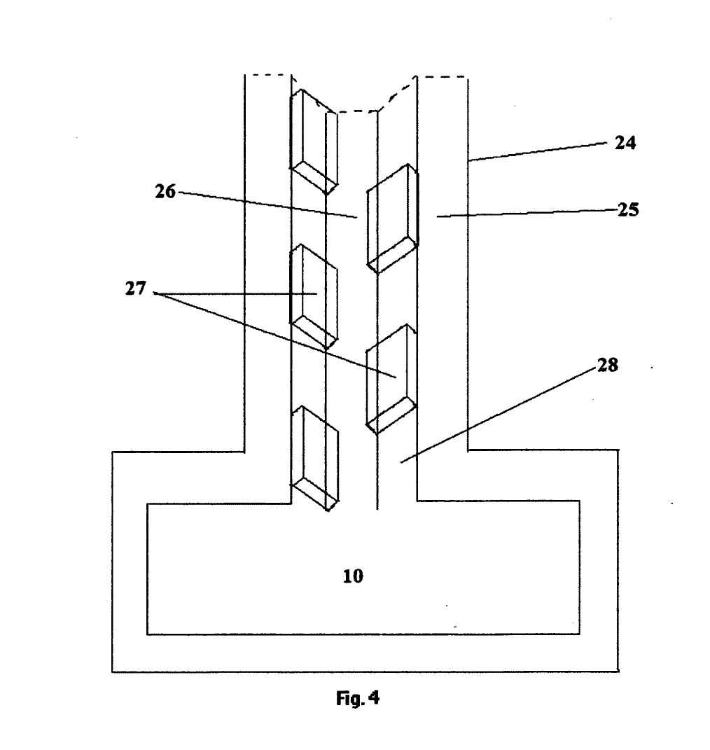

FIG. 5 is the front view while looking inside the slide of either type. You can see the hole that people fall through and the side walls.

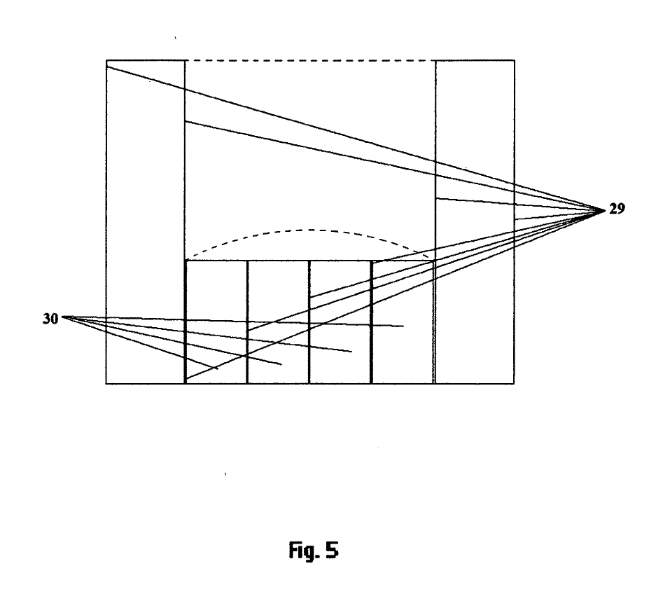

FIG. 6 is a view of looking down onto the bottom of the slide. From this view, you can see what the adjustable decelerators look like.

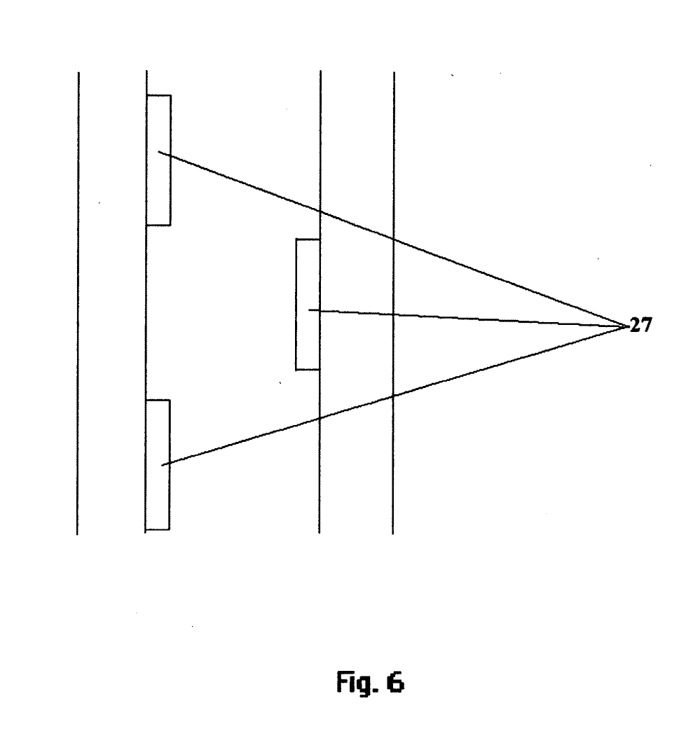

FIG. 7 is a front view of a folding machine for the inflatable slides. You can see the machine's claws grabbing one end of the slide. There is also a drawing of the folding machine by itself.

FIG. 8 is a close up picture of the folding machine.

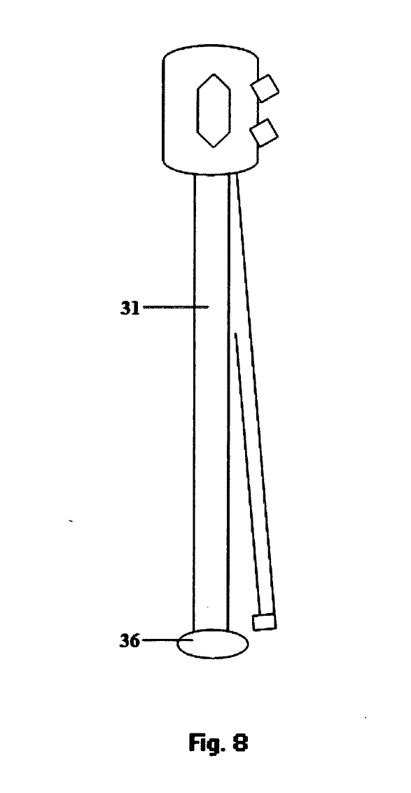

### DETAILED DESCRIPTION OF INVENTIONS

When something happens to a high-rise building in which an evacuation is needed, an alarm is activated, making air push onto the evacuation slides 13 in the emergency rooms 12, opening the windows 15, and unrolling itself down to the ground. The safety cables 11 will hold it back so it doesn't lay flat against the building 14, and the air will soon come into the inflatable evacuation slide 13 enough to where it will straighten itself out. In case of a power outage, a backup generator 3 will also be connected to use for the air compressor 2. During this time, a water pump 5 will also pump water into the winch 6 on top of the door, so water 22 will be sprayed everywhere in the room, and go down the slide 13. A back-up water tank 4 will also be in the room in case of water outage. Once the inflatable slide 13 is fully inflated, firemen will get water into a four foot deep pool 10 at the bottom of the slide 9. The pool is also an inflatable part of the slide 9; once the pool is full, victims will start sliding downwards on the slide 13. The 4 safety cables 11 and the foldable plastic wall 29 will make sure the slide not bend from weight. Air adjustable tubes 3 will also be used for the safety of the people. About every ten floors, there will be one slide 13 specifically for people over 250 pounds; these slides 13 will be better reinforced, and the tubes 3 will be adjusted so as to be fit in slowing down the people, and holding up the slide 13.

At a higher floor of a high rise building 13, there will be at least one emergency room 12 where the slides 13 are placed, so it will be quicker to evacuate from the building 14. Also, and most obviously, the emergency room 12 would have to be place where a window 15 is, so it can open out right away.

Once the fire trucks 16 come, in addition to helping the people out of the evacuation slide 13 of the high-rise building 14, and filling the pools of the slides 10, they will also be able to pull up their own forms of evacuation, which are the funnel-slides 20 that will be pulled up by the fire truck crane 17. Quick hooks 18 will be attached to the top of the crane from the steel frame 37 which is connected to the funnel-slide 20 for support. The layers of the slide part 8 are the same as the layers of the building evacuation slides 13, which shall be explained later. The funnel 20 can go as far up as the fire truck crane 17 can go, which is no more than thirty stories up. The fabric, as said before, is plastic polyester fabric 20, which is not too hard to break bones, not too thin to where it will rip, and not too bouncy to where people could bounce out. This allows people from three stories higher than the funnel at most to be able to land safely on the funnel 20, and slide down it, to the slide part 8. A water gun 21 will be attached to the crane 17 at the top to get water 22 into the funnel. Once someone reaches the free fall slide 8, the decelerators 29 will slow their descent down until they get to the bottom 9, where—like the high-rise building evacuation slide 13—the firemen will have to fill the four-foot deep pool 10 with water from the water guns 22. At opposite ends of the funnel are folding latches 19, which enable the metal rim 36 around the funnel 20 to be folded once the evacuation is over.

There are many features to the evacuation slide 13. For instance, the slide has a clear, plastic cover 7 to prevent cases of people falling out. This covering 7 is located over the top of the slide. It provides for good viewing of the evacuees, so as to direct traffic accordingly; and along with that, it keeps the people securely inside the slide 13 at all times. Also, there are adjustable air tubes 30 contained within the bottom of the slide 26. The tubes 30, when needed, can be inflated when smaller people pass through or deflated when larger and heavier people slide down. Another feature of this unique evacuation slide 13 is that it possesses decelerators 27, which are blocks that slow the speed of evacuating people. These decelerators 27 are positioned on alternating sides along the side of the slide.

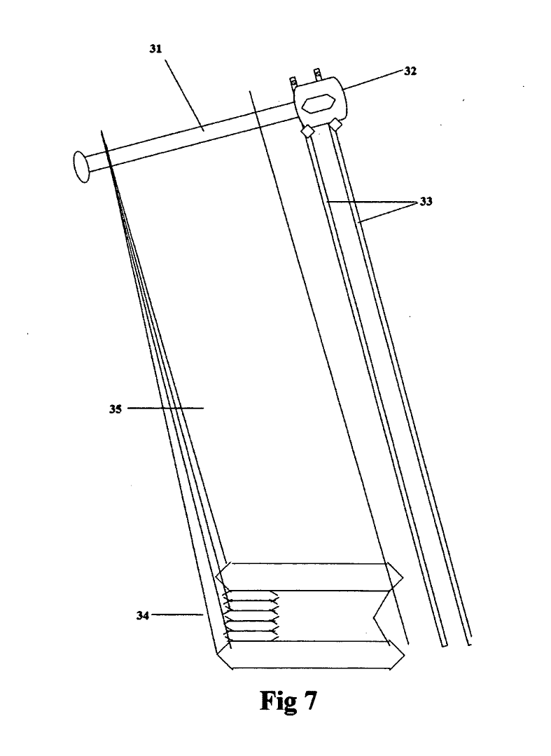

Now referring to FIG. 7, we have created a machine that would be most useful because of the fact that it can re-wrap the evacuation slides (funnels included) 13 after they are used, therefore, rendering the slide 13 as reusable. One should wait until the water dries before using this machine to roll up the slides. This simple mechanism functions by clamping one end of the slide with its locking clamp shaft 31 and rolling along a pair of rails 33 on a motor 32. This will make the machine rotate, wrapping the slide 13 into a tightly wrapped bundle. This also pushes air within the tube out. The slide 13 will then be re-installed into its beginning position, waiting for use.

What is claimed:

1. A sequence of steps to evacuate from a high rise building 14
a. Siren or other forms of alert
b. Evacuation slides 13 blast out from different places
c. People follow map routes to specific rooms 12 of evacuation while firemen come
d. Throw off dangling or sharp objects into storage room next to evacuation room 12 (purses, belts, suspenders, earrings, bracelets, necklaces, shoes, etc.). Firemen start getting water into pools 10, and setting up funnels 20.
e. Wait until firemen finish setting up, then evacuation begins
f. People start coming down one after another until everyone comes out
g. Wait until all slides 13 and funnels 20 dry off, then start wrapping them up with clamp 31.
h. Return funnels to fire trucks 16, and slides to their specific floors

2. An evacuation slide:
a. Decelerator blocks 27 that keep persons falling at a slow, steady speed; positioned on alternating sides
b. Vertical layers of plastic 29 to keep the slide from bending
c. A 4-feet pool 10 at the bottom that is connected to the slide 13 to keep people from hitting the ground too hard
d. Air compressor 2, winch 6, and back-up water tank 4 to keep the slide up and wet (in case of fire)
e. The structure: plastic walls 29 and adjustable air tubes 30
1) Plastic walls are the framework for the inflatable slide. They form smaller tunnels through which the air is pumped. These strips of plastic keep the slide from collapsing.
2) The adjustable air tubes control how much space there is within the slide. Pumping more air into the tubes causes the volume of space inside the slide to shrink.

3. A funnel 20 that can be connected to a fire truck 16
a. Polyester fabric 20 used in funnel
b. A 4-feet pool 10 at the bottom that is connected to funnel 20 to prevent people from hitting the ground too hard
c. A set of layers to keep the funnel 20 stable
d. A metal rim 36 to hold the fabric up and attach it to the fire truck's ladder 17
e. A way to connect to the crane 17 of the fire truck 16 to the funnel 20
1) Hooks and steel bars are attached to the tip of the crane

4. A slide folding machine consisting of:
a. Motor 32
b. long shaft 31
c. clamp
d. claw lock 35
e. pair of rails 33
f. Re-wraps the evacuation slides by clamping on the slide and rolling on a pair of rails
